(19) United States
(12) Patent Application Publication
(10) Pub. No.: US 2010/0250224 A1
(43) Pub. Date: Sep. 30, 2010

(54) POWER SOURCE NOISE ANALYSIS DEVICE AND ANALYSIS METHOD

(75) Inventors: Daisuke IGUCHI, Ebina-shi (JP); Takahiro HORIGUCHI, Ebina-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/640,472

(22) Filed: Dec. 17, 2009

(30) Foreign Application Priority Data
Mar. 25, 2009 (JP) 2009-074473
Aug. 27, 2009 (JP) 2009-196701

(51) Int. Cl. G06F 17/50

(52) U.S. Cl. 703/15

(57) ABSTRACT

A power source noise analysis device includes an analysis portion. The analysis portion estimates an internal impedance of a semiconductor chip being an object to be analyzed based on a power current waveform, which is obtained by simulation of the semiconductor chip based on design data of the semiconductor chip. The analysis portion carries out a noise analysis of a power system including a board having the semiconductor chip mounted thereon based on the internal impedance.

### CROSS-REFERENCE TO RELATED APPLICATIONS

This application is based on and claims priority under 35 USC 119 from Japanese Patent Application Nos. 2009-74473 (filed Mar. 25, 2009) and 2009-196701 (filed Aug. 27, 2009).

### BACKGROUND

The present invention relates to a power source noise analysis device and an analysis method.

### RELATED ART

Recently, in a printed circuit board, etc., which is composed by incorporating semiconductor chips, a multiple-layered substrate has been used, which has a power plane and a ground plane in order to supply, at a high rate, a transient current produced when a semiconductor element executes switching operations at a high rate, or the power source line and ground line are composed so as to have as low impedance as possible even in a double-sided substrate. That is, since the transient current produced by switching operations of the semiconductor chip flows from the power plane and the ground plane if the semiconductor element is actuated by supplying power thereto, a high-frequency current is induced between the power plane and the ground plane. The current causes a potential difference to be brought about at the end parts of the planes, or is caused to flow to the cable, etc., which is connected to the planes, wherein electromagnetic radiation is brought about.

### SUMMARY

According to an aspect of the invention, A power source noise analysis device includes an analysis portion. The analysis portion estimates an internal impedance of a semiconductor chip being an object to be analyzed based on a power current waveform, which is obtained by simulation of the semiconductor chip based on design data of the semiconductor chip. The analysis portion carries out a noise analysis of a power system including a board having the semiconductor chip mounted thereon based on the internal impedance.

### BRIEF DESCRIPTION OF THE DRAWINGS

Exemplary embodiments of the invention will be described in detail based on the following figures, wherein:

FIG. 1 is a block diagram showing a power source noise analysis device according to a first exemplary embodiment of the present invention;

FIGS. 2A and 2B are schematic views showing a structure of a semiconductor component according to the first exemplary embodiment of the present invention;

FIG. 3 is a schematic view showing connections between a semiconductor chip and a board, according to the first exemplary embodiment of the present invention;

FIG. 4 shows an equivalent circuit model of a power system used for processing of the power source noise analysis device according to the first exemplary embodiment of the present invention;

FIG. 5 is a flowchart showing processing of the power source noise analysis device according to the first exemplary embodiment of the present invention;

FIG. 6 is a view showing one example of data details of package characteristics used for analysis processing shown in FIG. 4;

FIG. 7 is a view showing a power current waveform obtained by simulation by the power source noise analysis device according to the first exemplary embodiment of the present invention;

FIG. 8 is a schematic view showing connection between a semiconductor chip and a board, according to a second exemplary embodiment of the present invention;

FIG. 9 is a circuit diagram showing a part of an equivalent circuit in which an electrostatic capacitance of the board, a resistance of the board and an impedance of the board are considered, according to the second exemplary embodiment of the present invention;

FIG. 10 is an explanatory view showing an example in which the board is divided into a large number of meshes, according to the second exemplary embodiment of the present invention;

FIG. 11 is a flowchart showing processing of a power source noise analysis device according to the second exemplary embodiment of the present invention;

FIG. 12 is a view showing a mesh dividing model which is used when an analysis is carried out in a frequency range being higher than a reference frequency, according to a third exemplary embodiment of the present invention;

FIG. 13 a view showing a modification example of the mesh dividing model, which is used when the analysis is carried out in the frequency range being higher than the reference frequency, according to the third exemplary embodiment of the present invention; and

FIG. 14 is an explanatory view showing an example of a transmission model according to a fifth exemplary embodiment of the present invention.

### DETAILED DESCRIPTION

### Configuration of Power Source Noise Analysis Device

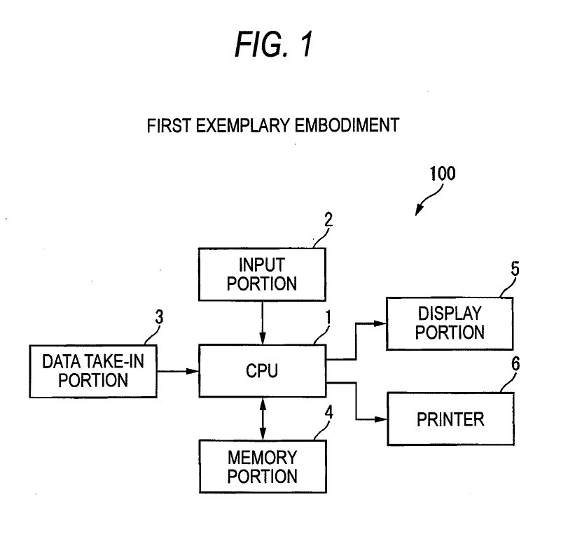

FIG. 1 is a block diagram showing a power source noise analysis device according to a first exemplary embodiment of the present invention. A power source noise analysis device 100 is provided with a CPU (analysis portion) 1 for controlling the entire device, an input portion 2 including a keyboard and a mouse (which are not illustrated), a data take-in portion 3 for taking-in data necessary for analysis of power source noise, a memory portion 4 made of a memory medium such as a hard disk drive, in which various types of data, programs to carry out analysis processing and results of calculations are stored, a display portion 5 for displaying the details of operation and actions, and a printer 6 for printing out the results of analysis, etc. Also, the input portion 2, the data collection portion 3, the memory portion 4, the display portion 5 and the printer 6 are normally connected to the CPU 1 via an interface. However, herein, the illustration thereof is omitted.

For example, an interface for connection to the Internet, a CD drive, a DVD drive, etc., may be used as the data collection portion 3.

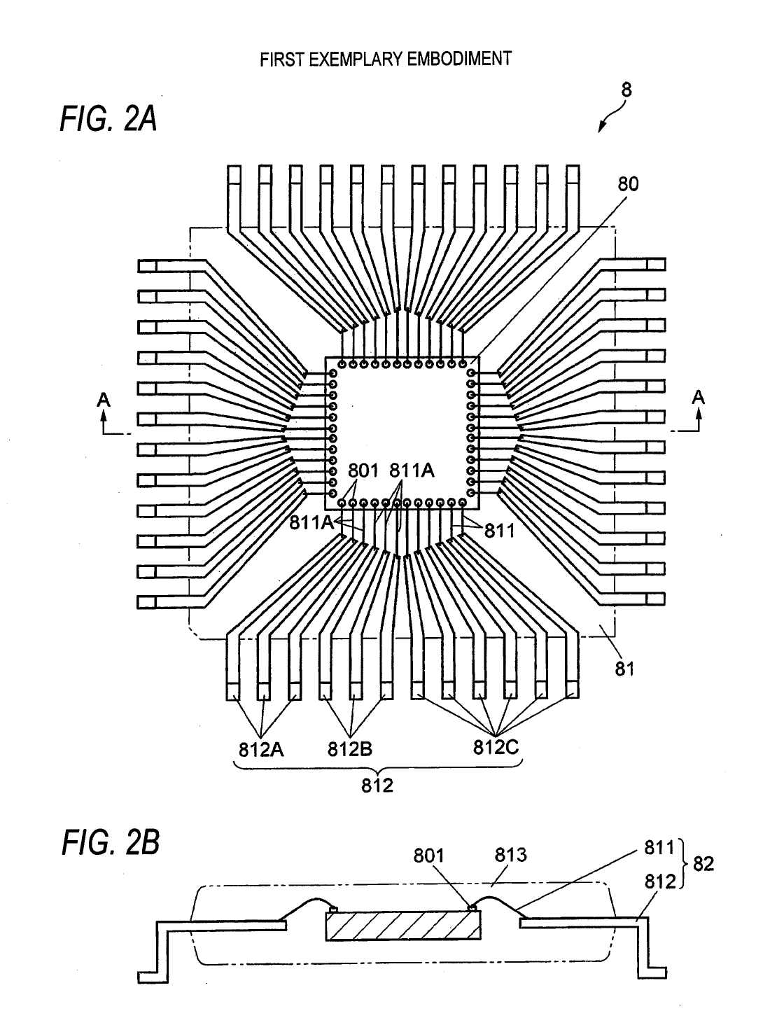

FIGS. 2A and 2B are schematic views showing a structure of a semiconductor component. FIG. 2A shows a mold resin 813, which seals a semiconductor chip 80 and the like of the semiconductor component 8, by chain double-dashed lines and is a view seen from a front face of the semiconductor component 8 (from a face opposite to a printed-circuit-board side. FIG. 2B is a section view taken along a line A-A in FIG. 2A.

The semiconductor component 8 includes the semiconductor chip 80 and a package part 81. Plural bonding pads 801 are provided on the front face of the semiconductor chip 80. The package part 81 has plural leads 812 which are provided to correspond to the plural bonding pads 801, respectively, plural wires 811 which connecting the plural boding pads 801 and the plural leads 812, and a mold resin 813 which seals the leads 812, and the like.

The wires 811 are boding wire formed by the wire bonding technique. One ends of the leads 812 are embedded in the mold resin 813 and are connected to the wires 811, and the other ends of the leads 812 are exposed to an outside of the mold resin 813. The mold resin 813 is, for example, made of an epoxy resin. As shown in FIG. 2B, the plural leads 812 and the plural wires 811 constitute a conductive part connecting a board and the semiconductor chip to each other.

The leads 812 include power-supply leads 812A which supply power to the semiconductor chip 80, ground leads 812B connected to the ground of the semiconductor chip 81 and non-power-supply leads 812C connected to various types of signal lines. The power-supply leads 812A and the ground leads 812B are connected to the bonding pads 801 of the semiconductor chip 80 by power-source wires 811A and ground wires 811B, respectively.

It is noted that, in the example shown in FIGS. 2A and 2B, three power-supply leads 812A and three ground leads 812B are provided. However, the number of the power-supply leads 812A and the number of the ground leads 812B are not limited thereto. One power-supply lead 812A and one ground lead 812B may be provided. Also, the power-supply lead(s) 812A and the ground lead(s) 812B may be provided so as not to be adjacent to each other, but so as to be arranged in a distributed manner.

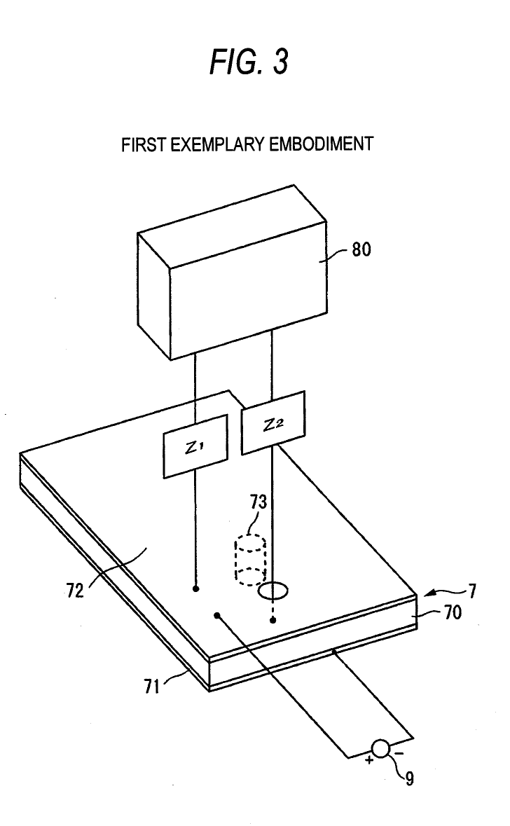

FIG. 3 is a schematic view showing connections between a semiconductor chip and a board. The power source noise analysis device 100 aims at noise analysis in a state where the semiconductor chip 80 having a semiconductor element performing a switching operation and a circuit is mounted on a board 7. As shown in FIG. 3, analysis is carried out based on a conductive state when power is applied from a power source 9 in a state where the semiconductor chip 80 is mounted on the board 7. In addition, in FIG. 3, the semiconductor chip 80 is shown in a state where it is separate from the board 7 for the sake of convenience in description.

The board 7 has a ground plane 71 (an example of a reference potential layer) provided on one side (the lower side of FIG. 3) of an insulation body 70 made of ceramic, polyimide, glass epoxy, etc., and a power plane 72 (an example of a power supply layer) provided on the other side thereof (the upper side of FIG. 3). The power source 9, which outputs a direct current voltage of, for example, 3.3V is connected between the power plane 72 and the ground plane 71.

The semiconductor component 8 is connected to the power source 9 via the ground plane 71 and the power plane 72. Actually, the semiconductor chip 80 is connected to the board 7 via the wirings 811 and the leads 812, and the board 7 and the semiconductor chip 80 are connected to each other through a number of wiring patterns such as data lines and control lines. However, in the figure, only the power system is illustrated. Impedances Z₁ and Z₂ that are brought about by the conductive part 82 are produced between the semiconductor chip 80 and the board 7. Description will be given on an equivalent circuit including the impedances Zᵢ and Z₂ with reference to a figure.

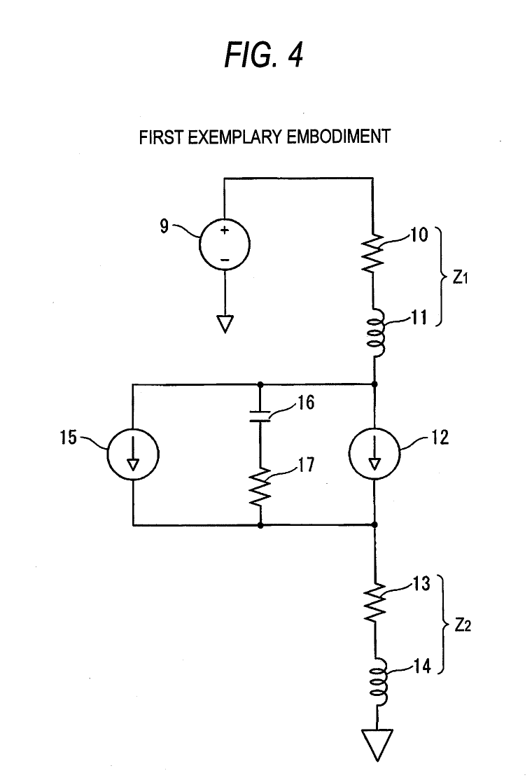

FIG. 4 shows an equivalent circuit model of a power system for use in processing of the power source noise analysis device according to this exemplary embodiment of the present invention. This equivalent model circuit expresses a simplified circuit of the semiconductor component 8 that is formed between positive and negative electrodes of the power source 9. In this equivalent circuit, a resistance 10, an inductor 11, a first current source 12, a resistor 13, and an inductor 14 are connected in series. A second current source 15 is connected to the first current source 12 in parallel, and a circuit in which a capacitor 16 and a resistance 17 are connected in series is connected to the first current source 12 in parallel.

The resistance 10 and the inductor 11 represent a resistance and an inductance of the power-supply leads 812A, which constitute a power-supply line of the semiconductor chip 80, and the wires 811A, that is, represent the impedance Z₁. Also, the resistance 13 and the inductance 14 represent a resistance and an inductance of the ground leads 812B, which constitute the ground line of the semiconductor chip 80, and the wires 811B, that is, represent the impedance Z₂.

The first and second constant current sources 12 and 15 are formed by the switching operation of the circuit, which constitutes the semiconductor chip 80, and the first constant current source 12 is a sum of a drive current of L-H transition and a transient current (through current), and the second constant current source 15 is a through current of the H-L transition. The capacitor 16 is an electrostatic capacitance between the power source and the ground of all the circuit elements that commonly have the same power supply system in the interior of the semiconductor chip 8. The resistor 17 is a resistance thereof. Here, the drive current is a current having a slight change in current, and the through current is a cyclic current, that is, a current that changes at a cycle of, for example, t=3.65 ns. If the impedance of the power system, which is observed from the semiconductor chip 80, is sufficiently low, the waveform (pulse width, cycle and wave height, etc.) thereof is does not change greatly.

### (Operation of Power Source Noise Analysis Device)

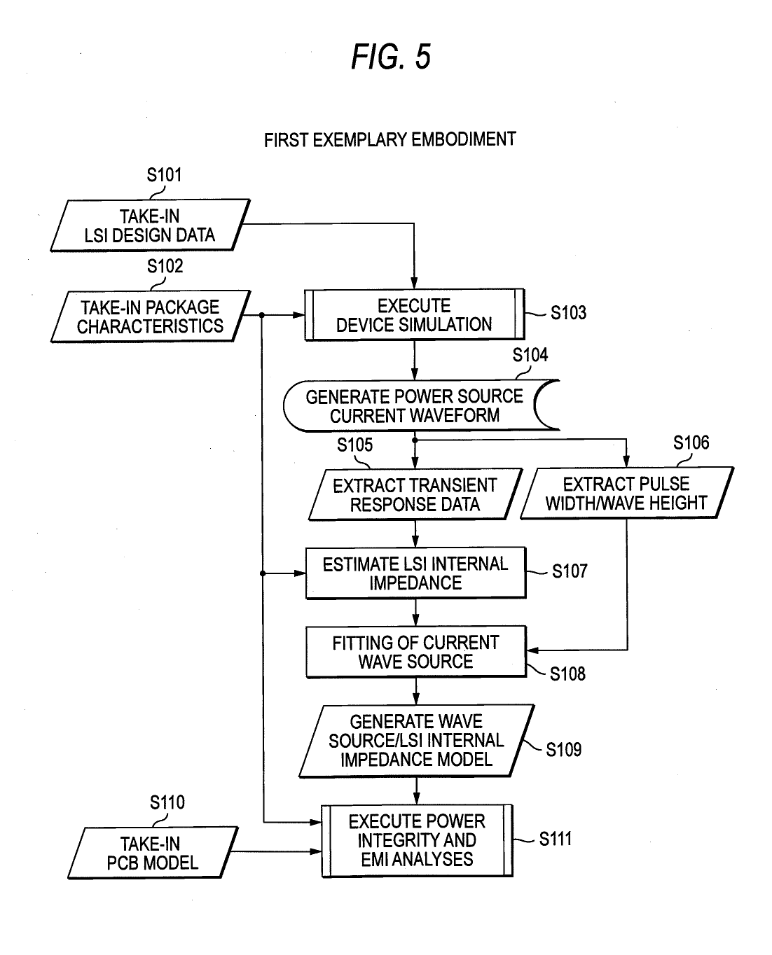

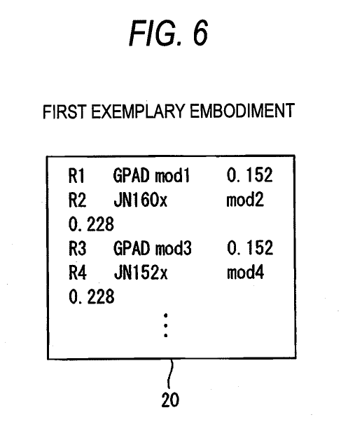

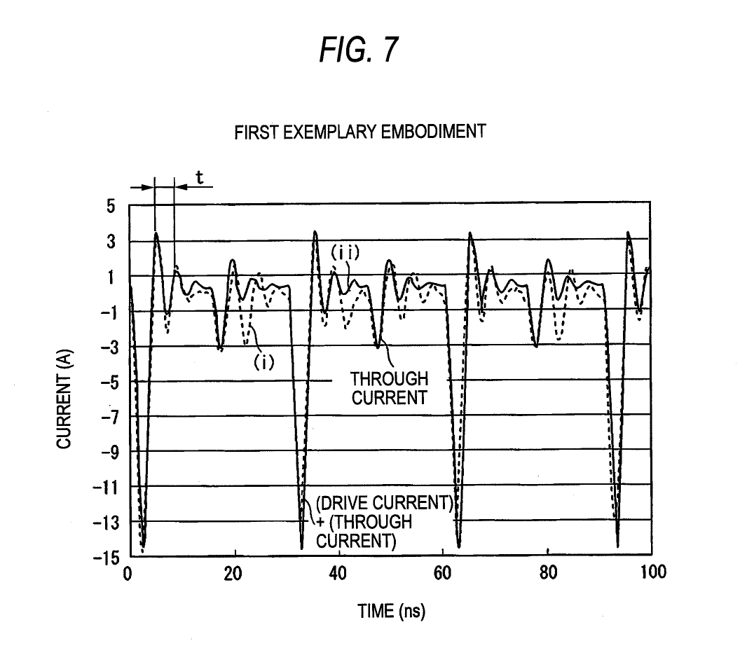

FIG. 5 is a flowchart showing processing of the power source noise analysis device according to this exemplary embodiment of the present invention. A program for executing the processing shown in FIG. 5 is stored in the memory portion 4 shown in FIG. 1. Further, FIG. 6 is a view showing one example of data details of package characteristics (package model or LSI library) for use in the analysis processing shown in FIG. 4. FIG. 7 is a view showing a power current waveform (i) obtained by a device simulation S103 of FIG. 5 in the power source noise analysis device according to this exemplary embodiment of the present invention, and a current waveform (ii) provided by a wave source and internal impedance model S109 estimated by the power source noise analysis device. In addition, in FIG. 7, a waveform portion dropped down to −15 A is a current peak produced by the drive current of the L-H transition described above and the transient current (through current). A portion dropped down to −3 A at the middle of the cycle thereof is produced by the drive current of the H-L transition described above.

First, prior to the analysis, an operator acquires LSI design data of the semiconductor chip 80 from a semiconductor manufacturer who manufactures the semiconductor chip 8 being an object to be analyzed (the semiconductor chip 80 under analysis), and takes the data in the power source noise analysis device 100 (S101). Further, the operator acquires a package model 20, which is described by a concentrated constant matrix of RLGC as exemplarily illustrated in FIG. 6, and takes it in the power source noise analysis device 100 (S102). The package model 20 is a model representing electric characteristics of the conductive part 82 which are calculated by the known electromagnetic field analysis technique based on section shapes the leads 812 and the wires 811 of the semiconductor chip 80. Also, a PCB (Printed Circuit Board) model is acquired and is stored in the memory portion 4 (S110).

Next, the operator operates the mouse and keyboard of the input portion 2 of the power source noise analysis device 100 to commence a device simulation (an example of first simulation) (S103). In this device simulation, the CPU 1 virtually cause the semiconductor chip 80 to operate, based on the LSI design data taken in at step S101 and the package model 20 taken in at step S102. This device simulation is carried out on the assumption that the board 7 is an ideal power source having no impedance. The CPU 1 executes the above Step S103 to generates a power current waveform, displays it on the display of the display portion 5, and prints it out by the printer 6 as necessary (S104).

This power current waveform is a current waveform of the power source which is brought into the semiconductor chip 80 under analysis from the board 7 through the package when power is supplied with the board 7 being regarded as an ideal power source. This power current waveform is obtained by calculation which uses, as data, (i) the LSI design data taken in at step S101 on an LSI design tool owned by the semiconductor manufacturer and (ii) the package characteristics taken in at step S102. The power-source current may be obtained by the above calculation or may be obtained from the semiconductor manufacturer.

The CPU 1 extracts a cycle t and a frequency f (=1/t) of the current transient response from the power current waveform (S105). The cycle t is determined by a series resonance of (i) an inductance L, which is a sum of an inductance L₁₁ of the inductor 11 and an inductance L₁₄ of the inductor 14, and (ii) a capacitance C of the capacitor 16. That is, the frequency f of the current transient response based on the cycle t of the current transient response is obtained based on the following equation by the CPU 1.

$$f = \frac{1}{2 π \sqrt{LC}} \qquad ( 1 )$$

When the capacitance C is obtained from the expression (1), the capacitance C is expressed by the following equation. The calculation is executed in step S107 by the CPU 1 based on the package model taken in at step S102.

$$C = \frac{{( t / 2 π )}^{2}}{L} \qquad ( 2 )$$

One example is given. It is assumed that L is 36 pH. In this case, the capacitance C is 9.37 nF (when the cycle of the current transient response is 3.65 ns). Also, the reason why the capacitance C is obtained as described above is that it is difficult to obtain the same from CAD (Computer Aided Design), etc.

On the other hand, the CPU 1 extracts a pulse width and a wave height of the power current waveform (waveform i in FIG. 7) generated in Step S104 described above (S106). Further, the CPU 1 carries out waveform fitting of the current sources 12 and 15 (S108). That is, the CPU 1 assumes that the current sources 12 and 15 are wave sources of triangular waves when an instantaneous waveform at a time of switching, which becomes an impact producing the transient response, is Gaussian-approximated, and operates mesial magnitudes and wave heights of the triangle waves so that a waveform obtained by the device simulation has the wave height and half-value width of the Gaussian waveform. Then, the CPU 1 generates a wave source/chip internal impedance model based on the result of the waveform fitting, that is, reproduces the transient response, which does not contain the PCB, like the waveform (ii) of FIG. 7 (S109). Next, the CPU 1 executes power integrity and EMI (Electromagnetic Interface) analyses based on the wave source/chip internal impedance model, the PCB model (waveform (i) in FIG. 7) acquired at step S110, and the package characteristics taken in at step S102 (S111).

Accordingly, it becomes possible to estimate, based on the transient response characteristics of the semiconductor component 8 when the board 7 is regarded as an ideal power supply, how much noise current flows when the semiconductor component 8 is mounted on the board 7, and how the noise current is electromagnetically radiated.

### Second Exemplary Embodiment

Next, a second exemplary embodiment of the present invention will be described. In the first exemplary embodiment, the power source noise analysis technique based on the transient response characteristics of the semiconductor component 8 when the board 7 is regarded as an ideal power source has been described. However, the power current of the semiconductor component 8 is affected by the impedance of the board 7. Therefore, in order to perform the power source noise analysis more accurately, it is necessary to perform analysis based on the transient response characteristics of the semiconductor component 8 in which the impedance of the board 7 is considered. Then, in this exemplary embodiment, a power source noise analysis device, which is based on the transient response characteristics of the semiconductor component 8 in which the PCB model is considered, will be described.

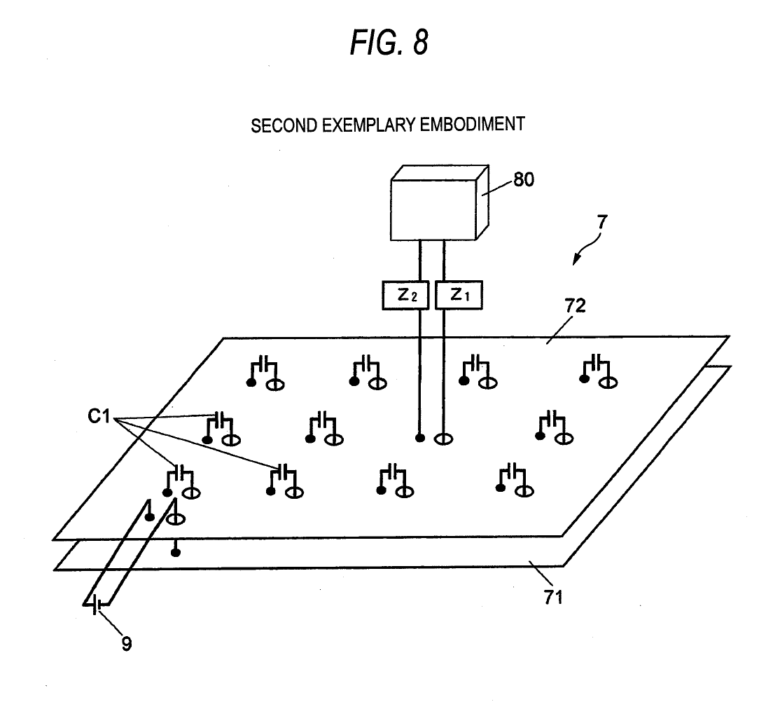

FIG. 8 is a schematic view showing connection between a semiconductor chip and a board, according to the second exemplary embodiment of the present invention. The board 7 may be expressed so that an electrostatic capacitance between the power plane 72 and the ground plane 71 being regarded as a large number of condensers C1 arranged therebetween. When a current flows through the power plane 72 and the ground plane 71, a resistance occurs as well as an inductance.

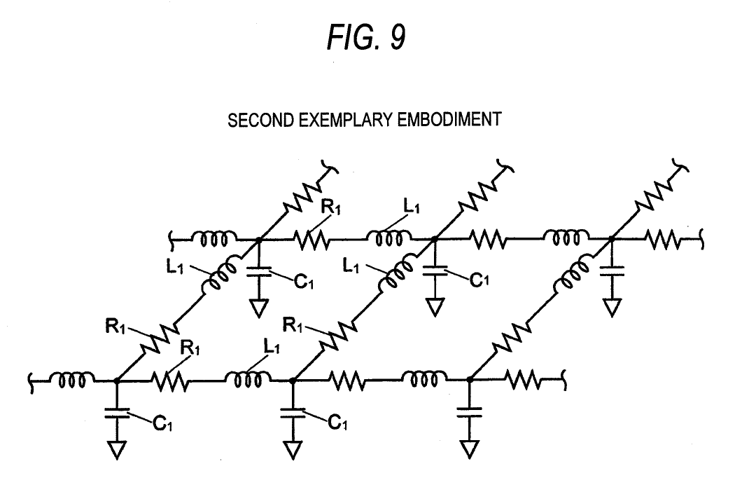

FIG. 9 is an example of a circuit diagram showing a part of an equivalent circuit in which an electrostatic capacitance, a resistance and an impedance of the board 7 are considered. This equivalent circuit is formed of the following circuit. That is, a large number of grid-shape meshes are arranged on a plane. Each mesh has four sides in each of which a resistor R₁ and an inductor L₁ are connected in series. A condenser C₁ is connected to vertices of each mesh. An electrostatic capacitance of the condenser C_{I}, a resistance value of the resistor R₁, and an inductance of the inductor L₁ can be obtained based on the design data of the board 7.

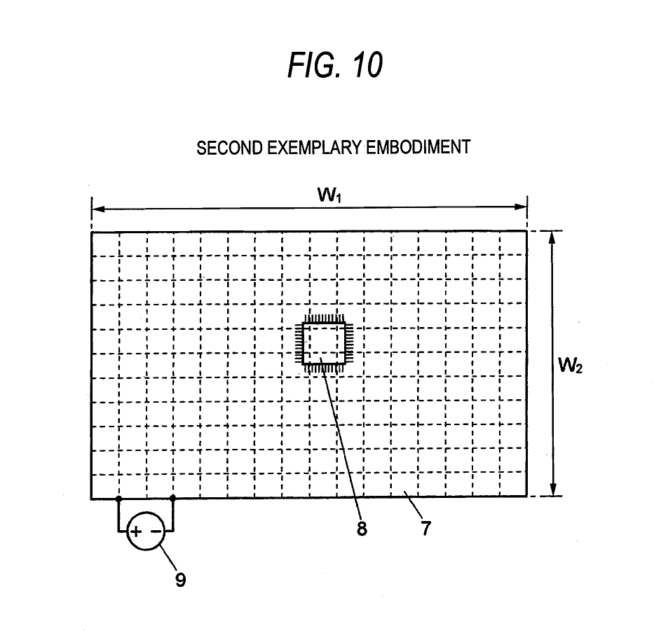

FIG. 10 is an explanatory view showing an example in which the board 7 is divided into a large number of meshes. As shown in this figure, the board 7 has a rectangle shape, and it is assumed that W₁ denotes the length of the long side of the board 7 and that W₂ denotes the length of the short side of the board 7. A quadrangle portion surrounded by a solid line(s) (an end face(s) of the board 7) and/or broken lines in this figure represents one mesh. The entire board 7 is divided uniformly.

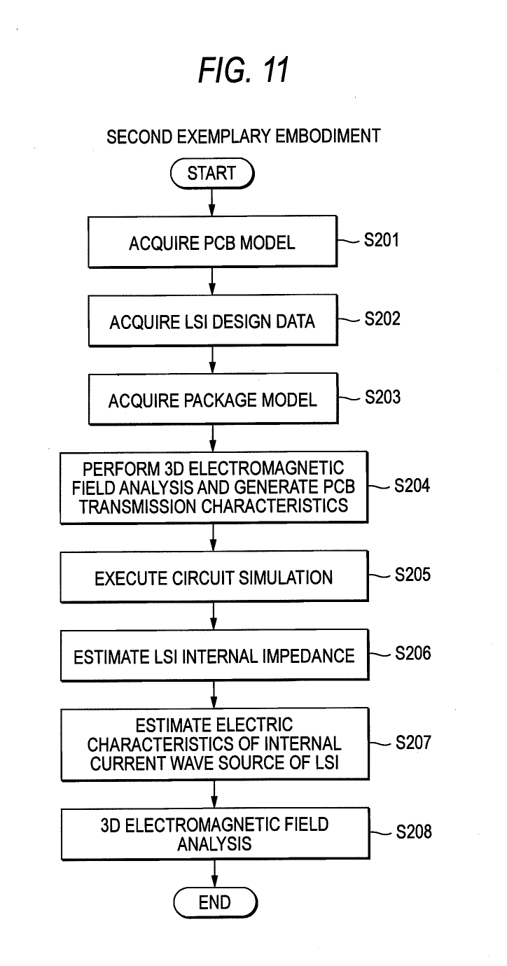

FIG. 11 is a flowchart showing processing of the power source noise analysis device according to the second exemplary embodiment of the present invention. The configuration of the power source noise analysis device is similar to that shown in FIG. 1, and a program that executes the flowchart shown in FIG. 11 is stored in the memory portion 4 (see FIG. 1).

Prior to the analysis, the CPU 1 acquires a PCB model and stores it in the memory portion 4 (S201). The PCB model is given as circuit constants (the electrostatic capacitance of the capacitor C₁, the resistance value of the resistor R₁, and the inductance of the inductor L₁) of the equivalent circuit shown in FIG. 9. Also, the CPU acquires the LSI design data of the semiconductor chip 80 and stores it in the memory portion 4 (S202). Furthermore, the CPU 1 acquires the package model 20, which is described by a concentrated constant matrix of RLGC, and stores it in the memory portion 4 (S203).

Then, the CPU 1 performs, based on the PCB model acquired at step S201, an electromagnetic field analysis of (i) the power plane of the board, (ii) the power wiring and ground plane of the board or (iii) the ground wiring of the board by two or three dimensional electromagnetic filed analysis technique in a frequency range containing frequency having a board length (W₁ or W₂) of the board 7 as an electrical length, to thereby generate a PCB transmission characteristic model (S204).

This PCB transmission characteristic model is, for example, a transmission characteristic from a power input of the printed circuit board to a power pin of an LSI to which the printed circuit board is connected. Assuming that the former is a port 1 and that the latter is a port 2 (referring the ground), the PCB transmission characteristic model is described by the known S parameters of S11, S12, S21 and S22. The S parameters are described in the known TOUCHSTONE format, and can be directly taken in a circuit simulation tool (which will be described later). Also, the S parameters may be replaced by a circuit, model which well approximates the S parameters, and the circuit model may be taken in. In the case where the power pin is multiple pins, the PCB transmission characteristic model may be described by S parameters for multiple pins rather than the S parameters for the two pins. For the sake of simplicity, ports on the LSI side may be consolidated into one port.

The electrical length indicates an actual wavelength when a high-frequency current flows through an object in interest. The electrical length λ (m) can be obtained by the following equation:

$$λ = \frac{300}{f 1} \times ( length shorening factor ) \qquad ( 3 )$$

where f1 denotes frequency (MHz).

By transforming the equation (3), we can obtain the following equation (4):

$$f 1 = \frac{300}{λ} \times ( length shortening factor ) \qquad ( 4 )$$

Here, the length shortening factor represents an effect of preventing a current from flowing through an object in interest, and may be called a speed factor.

Then, the CPU 1 executes a circuit simulation (which is an example of second simulation) for causing the semiconductor chip 80 to virtually operate in a state where the semiconductor chip 80 is mounted on the board, based on the PCB transmission characteristic model generate at step S204, the LSI design model acquired at step S202, the package model 20 acquired at step S203 (S205).

This circuit simulation is a voltage/current analysis by a nodal equation using the PCB transmission characteristic model (the S parameters or the approximated circuit model), the characteristic model of the package (the S parameters or the approximated circuit model), and the device model of the LSI, and can be executed by various commercially available tools. As such tools, for example, SPICE (Simulation Program with Integrated Circuit Emphasis) and its subsets are available.

Then, the CPU 1 estimates an internal impedance of the LSI based on the LSI design data acquired at step S202, and the package model 20 acquired at step S203 (S206). The processing at step S206 is performed with the board 7 being regarded as an ideal power source, and specific details of the processing are similar to steps S103, S104, S105 and S107 of the flowchart shown in FIG. 5 in the first exemplary embodiment.

Then, the CPU 1 estimates an electrical characteristic of an internal current wave source of the LSI and generates a current source model based on the result of the circuit simulation at step S205 and the internal impedance of the LSI estimated at step S206 (S207).

This current source model is an integral of currents which are estimated based on a current flowing through the package when the internal impedance of the LSI and the package model are connected to each other and which are caused by an switching operation of the transistor in the LSI. In the general three-dimensional electromagnetic field analysis, a non-linear semiconductor device cannot be connected as a wave source, and it is necessary to use, as a wave source, one in which this current wave source model and the internal impedance of the LSI are connected in parallel as shown in FIG. 4.

Then, the CPU 1 performs a three-dimensional electromagnetic field analysis based on the PCB model acquired at step S201, the current source model generated at step S207, and the internal impedance of the LSI estimated at step S206, that is, performs radiation EMI analysis.

Accordingly, the power source noise analysis based on simulation of a circuit including the semiconductor component 8 in which the PCB model is considered can be performed.

### Third Exemplary Embodiment

Next, a third exemplary embodiment of the present invention will be described. This exemplary embodiment is different from the second exemplary embodiment in the processing for generating the PCT transmission characteristic model at step S204 in the flowchart, which has been described with reference to FIG. 11 in the second exemplary embodiment.

In this exemplary embodiment, electromagnetic field analysis is performed by techniques, which are different in accuracy, in a higher frequency range than a frequency (which may be referred to as “reference frequency”) having the board length of the board 7 as its electrical length and in a lower frequency range than the reference frequency. That is, in the frequency range lower than the reference frequency, the electromagnetic field analysis is performed using a simplified technique which can reduce a calculation load.

When the board 7 has a rectangle shape as shown in FIG. 10, it is desirable to use, as the reference frequency, the frequency having the length of the short side W₂ as its electrical length. However, the frequency having the length of the long side W₁ as its electrical length may be used as the reference frequency. That is, the reference frequency may be defined in any manner so long as it is determined based on a size of the board.

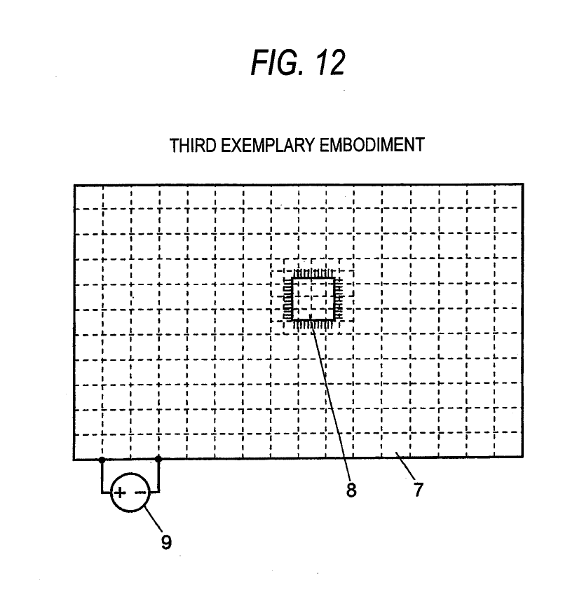

FIG. 12 is a view showing a mesh dividing model which is used when an analysis is carried out in a frequency range being higher than the reference frequency. As shown in this figure, the analysis is performed using a model in which, in the higher frequency range than the reference frequency, a neighboring portion of the semiconductor component 8 is divided into finer meshes than meshes into which a peripheral portion of the board 7 is divided. In the example shown in FIG. 12, the area of each mesh in the peripheral portion of the board 7 is the same as that in the dividing model shown in FIG. 10. However, with respect to the neighboring portion of the semiconductor component 8, the analysis is performed using the meshes each having the area as large as a quarter of the area of the mesh in the peripheral portion of the board 7. On the other hand, in the lower frequency range than the reference frequency, a dividing model which is the same as one shown in FIG. 10 is used.

In this manner, the different models are employed in the higher frequency range than the reference frequency and the lower frequency range than the reference frequency.

In the lower frequency range than the reference frequency, the electromagnetic field analysis is performed by the technique in which the calculation amount (calculation load) is reduced. Thereby, the calculation amount is reduced in comparison with the case where the same model (the model in which the neighboring portion of the semiconductor component 8 is divided finely) is used for the entire frequency range.

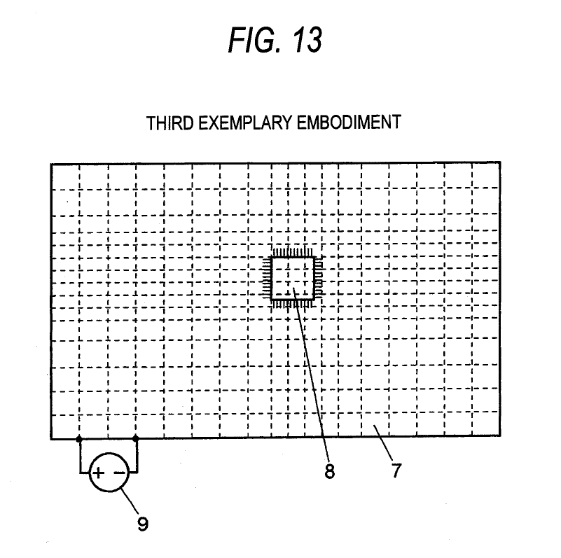

The mesh dividing model for use in the analysis for the higher frequency range than the reference frequency range may be modified in various ways. For example, as shown in FIG. 13, intervals of the meshes in a direction along the long side containing the neighboring portion of the semiconductor component 8 and in a direction along the short side containing the neighboring portion of the semiconductor component 8 may be narrower than those for the other portions. Alternatively, for example, in the case of the BGA (Ball grid array) package, the higher frequency range than the reference frequency may be analyzed by dividing into fine meshes so that one mesh corresponds to one electrode.

### Fourth Exemplary Embodiment

Next, a fourth exemplary embodiment of the present invention will be described. In the fourth exemplary embodiment, a calculation method used in generating the PCB transmission characteristic model is changed in the higher frequency range than the reference frequency and in the lower frequency range than the reference frequency. Thereby, the calculation load of the electromagnetic filed analysis in the lower frequency range than the reference frequency is reduced.

For example, the electromagnetic field analysis is performed by the finite difference method in the higher frequency range than the reference frequency, while the electromagnetic field analysis is performed by the boundary element method in the lower frequency range than the reference frequency. The finite difference method is a method for dividing an entire region into small regions and using an interpolation equation common to the respective small regions to thereby perform approximation by a mathematical model. The boundary element method obtains approximate solution only by discretization on a boundary. Three-dimensional discretization on the boundary is performed on a curved surface. Therefore, the boundary element method is less accurate than the finite difference method, but the boundary element method requires less numbers of elements and node points, which are required in discretization. As a result, the calculation load is reduced.

Also, in the lower frequency range than the reference frequency, a coupling between elements which constitute a electric circuit is relatively small. Therefore, for example, an equivalent circuit based on the transmission-line theory such as the Transmission Matrix Method may be used.

Accordingly, in the lower frequency range than the reference frequency, the method which is less accurate than that used in the higher frequency range than the reference frequency and reduces the calculation load is used to perform the analysis. Thereby, the calculation amount is reduced in comparison with the case where the same method (the method which is used in analyzing the higher frequency range than the reference frequency) is used to perform analysis in the entire frequency range under analysis.

### Fifth Exemplary Embodiment

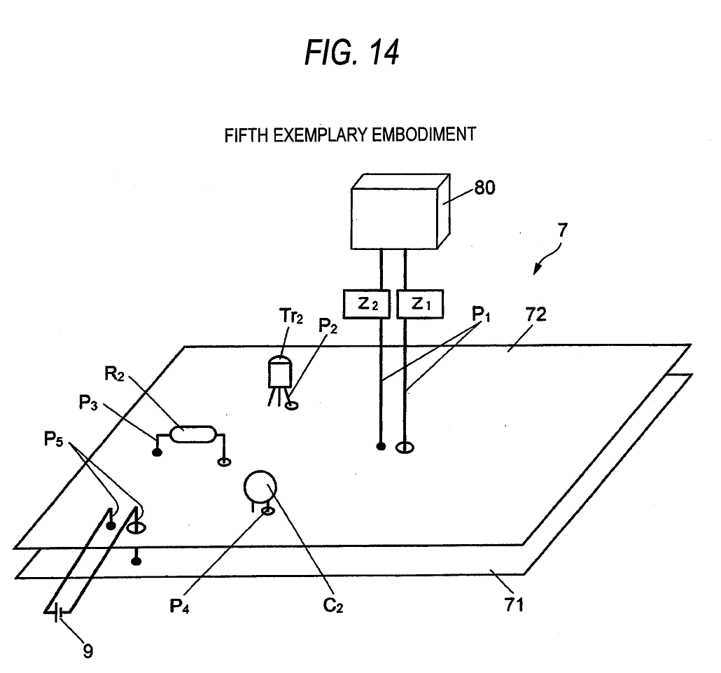

FIG. 14 is an explanatory view showing an example of a transmission model according to a fifth exemplary embodiment of the present invention. In this exemplary embodiment, connection points between (i) elements mounted on the board 7 other than the semiconductor chip 80 and (ii) the power plane 72 or the ground plane 71 are assumed as input/output ports.

In the example shown in FIG. 14, a transistor Tr₂ which is an example of an active element and a resistor R₂ and a condenser C₂ which are examples of a passive element are mounted on the board 7 as well as the semiconductor chip 80. As show in this figure, it is assumed that ports P₁ are connection points between (i) the semiconductor chip 80 and (ii) the power plane 72 and the ground plane 71; and ports P₂, P₃, P₄ are connection points between (i) the transistor Tr₂, the resistor R₂ and the condenser C₂ and (ii) the power plane 72 or the ground plane 71, respectively. Also, it is assumed that ports P₅ are connection points between (i) the power source 9 and (ii) the power plane 72 and the ground plane 71.

With this transmission model, the electromagnetic field analysis is performed with connections between (i) active elements or passive elements other than the semiconductor chip 80 and (ii) the power plane 72 and the ground plane 71 being considered.

### Other Exemplary Embodiments

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

For example, the board 7 is not limited to a rectangle, but may have an L shape or a arc shape. In this case, the reference frequency may be defined base on a length of any of the sides of the board or an intermediate value among lengths of plural sides of the board.

Also, the semiconductor chip 80 may be directly mounted on the board 7 without the leads 812 provided therebetween.

What is claimed is:

1. A power source noise analysis device comprising:
an analysis portion that estimates an internal impedance of a semiconductor chip being an object to be analyzed based on a power current waveform, which is obtained by a simulation of the semiconductor chip based on design data of the semiconductor chip, and carries out a noise analysis of a power system including a board having the semiconductor chip mounted thereon based on the internal impedance.

2. The power source noise analysis device according to claim 1, further comprising:
a processor that controls the analysis portion.

3. The power source noise analysis device according to claim 1, wherein the analysis portion obtains an electrostatic capacitance of the internal impedance based on a transient cycle of the power current waveform and an inductor of the power system of the semiconductor chip.

4. The power source noise analysis device according to claim 1, wherein the analysis portion carries out noise analysis of the power system based on the transient response waveform obtained at the stage of design of the semiconductor chip.

5. The power source noise analysis device according to claim 1, wherein
the analysis portion carries out the simulation of the semiconductor chip in a state where the semiconductor chip is mounted on the board, based on (i) transmission characteristic information of the board which is obtained by electromagnetic field analysis based on design data of the board, (ii) the design data of the semiconductor chip, and (iii) characteristic information of a conductive part connecting the semiconductor chip and the board to each other,
the analysis portion estimates an internal current of the semiconductor chip in the state where the semiconductor chip is mounted on the board, based on information of a result of the simulation and the estimated internal impedance of the semiconductor chip, and
the analysis portion carries out the noise analysis of the power system based on the internal current, the internal impedance of the semiconductor chip and the design data of the board.

6. The power source noise analysis device according to claim 5, wherein
in the carrying out of the electromagnetic field analysis to obtain the transmission characteristic information of the board, the analysis portion carries out the electromagnetic field analysis in a frequency range which is lower than a reference frequency of an electromagnetic wave being defined based on a size of the board, at a lower accuracy than the electromagnetic field analysis in a frequency range which is higher than the reference frequency.

7. The power source noise analysis device according to claim 6, wherein in the electromagnetic field analysis in the frequency range higher than the reference frequency, the analysis portion carries out the electromagnetic field analysis of a part of the board in which the semiconductor chip is mounted, at a higher accuracy than the electromagnetic field analysis of the other parts of the board.

8. The power source noise analysis device according to claim 5, wherein in carrying out of the electromagnetic field analysis of a transmission characteristic of the board, the analysis portion uses a transmission model having, as input and output point, a connection point between an element mounted on the board and a power supply layer of the board or a reference potential layer of the board.

9. A method for analyzing power source noise, comprising:
generating a power current waveform by simulation of a semiconductor chip being an object to be analyzed, based on design data of the semiconductor chip;
estimating an internal impedance of the semiconductor chip based on the power current waveform; and
carrying out a noise analysis of a power system including a board having the semiconductor chip mounted thereon based on the internal impedance.
